(19) United States
(12) Patent Application Publication
(10) Pub. No.: US 2010/0151173 A1
(43) Pub. Date: Jun. 17, 2010

(54) POLYAMIDE MATERIALS HAVING HIGH FLUID BARRIER PROPERTIES

(76) Inventor: Nicolangelo Peduto, Milano (IT)

Correspondence Address: BUCHANAN, INGERSOLL & ROONEY PC, POST OFFICE BOX 1404, ALEXANDRIA, VA, 22313-1404, US

(21) Appl. No.: 12/597,083

(22) PCT Filed: Apr. 24, 2008
(86) PCT No.: PCT/EP08/55018

§ 371 Date: Feb. 25, 2010

(30) Foreign Application Priority Data
Apr. 27, 2007 (FR) 0703069

(51) Int. Cl. B32B 27/08; C08L 61/06; C08L 47/00; B32B 1/08; B32B 1/02

(52) U.S. Cl. 428/36.9; 524/509; 524/511; 428/476.3; 428/35.7

(57) ABSTRACT

Polyamide materials having high fluid, e.g., gas, and liquid barrier properties are useful as articles for containing or conveying fluids, in particular tubes, ducts or tanks.

The present invention relates to polyamide materials having high barrier properties to fluids, gases and liquids. These materials may especially be used for the manufacture of articles intended to contain or transport a fluid such as, in particular, pipes, ducts or tanks.

### PRIOR ART

It is known from the prior art to use thermoplastic materials for the manufacture of single-layer or multilayer articles intended to contain or to transport a fluid such as, for example, pipes, ducts or tanks.

However, it is often necessary to carry out improvements to these materials in order to give them satisfactory barrier properties to gases or to liquids.

It is, for example, known to use multilayer, especially three-layer, pipes or tanks; each layer possibly being composed of different materials in order to give the assembly the required barrier and mechanical properties depending on the applications. Mention may especially be made of the polyethylene-ethylene/vinyl alcohol copolymer-polyethylene multilayer articles, a compatibilization layer being used between each layer. However, such articles, especially pipes, are costly to produce, and the conversion of EVOH results in a need to clean the extruder, which tends to reduce the productivity of the manufacture of these articles. Furthermore, problems of delaminations may occur between the incompatible materials of the various layers.

It is also known to use, in order to decrease the permeability of plastic matrices, especially polyamide matrices, lamellar nanofillers. Such a reduction in permeability is attributed to a “tortuosity” effect caused by these nanofillers. The lamellar nanofillers which are most widely investigated today are clays of smectite type, mainly montmorillonite. However, it is difficult to use these products insofar as it is necessary to exfoliate them in the matrix in particular by using intercalation agents in order to obtain individual lamellae having a high aspect ratio.

Thus, to date, solutions that are complex, difficult to implement and costly have been proposed in the prior art in order to increase the barrier properties of plastic materials; furthermore, often at the expense of the other properties of the plastic materials, such as in particular the mechanical properties.

It is thus desirable to develop polyamide materials that make it possible to obtain effective levels of impermeability, while avoiding the drawbacks mentioned previously.

### Invention

The Applicant has quite surprisingly demonstrated that the use, in a polyamide matrix, of a novolac resin and of a polyolefin made it possible to obtain a material suitable for the manufacture of single-layer or multilayer articles having an excellent level of impermeability to gases and to liquids, in a simple manner and without negatively altering the other properties of said materials. The solution of the invention makes it possible not only to avoid the drawbacks known from the prior art, but also to obtain hitherto unheard of fluid barrier properties, that are in any case much higher than the systems used commercially.

The polyamide materials of the invention also have good mechanical properties such as for example a good modulus/impact compromise, and/or a heat resistance enabling it to be handled and used at high temperatures.

The compositions of the invention additionally make it possible to manufacture, in combination with polyolefin materials, multilayer structures such as, for example, extruded pipes, articles produced by the extrusion-blow molding process, injection-molded and welded articles, having an excellent adhesive strength with the polyolefin materials, and to avoid any delamination problems. Such a composition furthermore makes it possible to do without the use of a compatibilization layer between said composition of the invention and a polyolefin material.

The invention thus relates to a polyamide composition having high fluid barrier properties comprising at least:

a) a polyamide matrix;
b) a novolac resin;
c) a polyolefin that does not comprise functional groups intended to improve its compatibility with the polyamide; and
d) an agent for compatibilization between the polyolefin and the polyamide.

Another subject of the present invention is an impermeabilization system for a polyamide matrix comprising a novolac resin, a polyolefin that does not comprise functional groups intended to improve its compatibility with the polyamide, and an agent for compatibilization between the polyolefin and the polyamide. The components of this system may be added together or in a deferred manner to a polyamide matrix.

The invention also relates to the use of a novolac resin, of a polyolefin that does not comprise functional groups intended to improve its compatibility with the polyamide, and of an agent for compatibilization between the polyolefin and the polyamide, in, or in connection with increasing the impermeability to fluids of, a polyamide matrix.

The expression “materials having high barrier properties to fluids” is understood to mean a material that has a reduced permeability in relation to a fluid. According to the present invention, the fluid may be a gas or a liquid. As gases, mention may especially be made of oxygen, carbon dioxide, light hydrocarbons such as ethane, propane, ethylene and propylene, and water vapor. As liquids, mention may be made of apolar solvents, especially the representative solvents of gasolines such as toluene and isooctane, and/or polar solvents such as water and alcohols, coolants. It should be noted that the liquids may have variable viscosities, such as in particular the high-viscosity liquids that are similar to gels or creams.

As the polyamide a) according to the invention, mention may be made of semicrystalline or amorphous polyamides and copolyamides such as aliphatic polyamides, semi-aromatic polyamides and, more generally, the linear polyamides obtained by polycondensation between an aliphatic or aromatic saturated diacid and an aromatic or aliphatic saturated primary diamine, the polyamides obtained by condensation of a lactam, of an amino acid or the linear polyamides obtained by condensation of a mixture of these various monomers. More specifically, these copolyamides may be, for example, polyhexamethylene adipamide, the polyphthalamides obtained from terephthalic and/or isophthalic acid, the copolyamides obtained from adipic acid, from hexamethylenediamine and from caprolactam.

According to one preferential embodiment of the invention, the thermoplastic matrix is a polyamide chosen from the group comprising the polyamide PA-6, the polyamide PA-6,6, the polyamide PA-11, the polyamide PA-12, the polymeta-xylylenediamine (MXD6), and the blends and copolymers based on these polyamides.

The polyamide is preferably chosen from the group comprising the polyamides obtained by polycondensation of a linear carboxylic acid with a linear or cyclic diamine such as PA-6,6, PA-6,10, PA-6,12, PA-12,12, PA-4,6, MXD-6 or between an aromatic carboxylic diacid and a linear or aromatic diamine such as polyterephthalamides, polyisophthalamides, polyaramids, the polyamides obtained by polycondensation of an amino acid to itself, the amino acid possibly being generated by hydrolytic opening of a lactam ring such as, for example, PA-6, PA-7, PA-11 and PA-12.

The composition of the invention may also comprise the copolyamides derived, in particular, from the above polyamides, or the blends of these polyamides or copolyamides.

The preferred polyamides are polyhexamethylene adipamide, polycaprolactam, or copolymers and blends of polyhexamethylene adipamide and polycaprolactam.

Use is generally made of polyamides having molecular weights suitable for injection-molding processes, although it is possible to also use polyamides of lower viscosities.

The polyamide matrix may especially be a polymer comprising star or H-shaped macromolecular chains, and where appropriate linear macromolecular chains. Polymers comprising such star or H-shaped macromolecular chains are, for example, described in documents FR2743077, FR2779730, U.S. Pat. No. 5,959,069, EP0632703, EP0682057 and EP0832149.

According to another particular variant of the invention, the polyamide matrix of the invention may be a polymer of random tree type, preferably a copolyamide having a random tree structure. These copolyamides of random tree structure and also the method of obtaining them are especially described in document WO 99/03909. The matrix of the invention may also be a composition comprising a linear thermoplastic polymer and a star, H-shaped and/or tree thermoplastic polymer as described above. The matrix of the invention may also comprise a hyperbranched copolyamide of the type of those described in document WO 00/68298. The composition of the invention may also comprise any combination of linear, star, H-shaped, tree thermoplastic polymer or hyperbranched copolyamide as described above.

The composition according to the invention preferably has from 40 to 80% by weight of polyamide, relative to the total weight of the composition.

The novolac resins are generally polyhydroxy compounds, for example condensation products of phenolic compounds with aldehydes. These condensation reactions are generally catalyzed by an acid.

The phenolic compounds may be chosen alone or as a mixture from phenol, cresol, xylenol, naphthol, alkylphenols, such as butylphenol, tert-butylphenol or isooctylphenol; or any other substituted phenol. The aldehyde most frequently used is formaldehyde. Use may however be made of other aldehydes, such as acetaldehyde, para-formaldehyde, butyraldehyde, crotonaldehyde and glycoxal.

The resins used advantageously have a high molecular weight between 500 and 3000 g/mol, preferably between 800 and 2000 g/mol.

As a commercial novolac resin, mention may especially be made of the commercial products Durez®, Vulkadur® or Rhenosin®.

The composition according to the invention may comprise between 0.1 and 20% by weight of novolac resin, especially from 1 to 15% by weight, particularly 2, 5 or 10% by weight, or proportions between these values, relative to the total weight of the composition.

As explained previously, the composition of the invention comprises a polyolefin that does not comprise functional groups intended to improve its compatibility with the polyamide.

For information, these groups are generally maleic anhydride, salified or unsalified carboxylic acid, ester, acrylic, methacrylic or epoxy groups; which are, for example, integrated into the polyolefin by the use of a comonomer, such as maleic anhydride.

The polyolefins of the invention advantageously have a degree of crystallinity between 40 and 80%. The degree of crystallinity is linked to the density by the following equation:

C=dc(d−da)/d(dc−da)

in which: C=crystallinity, d=density measured, da=density of the amorphous phase, dc=density of the crystalline phase at the given temperature.

The crystallinity may especially be measured by DSC.

These polyolefins preferably have a density between 0.910 and 0.97 g/cm³.

As preferred polyolefins of the present invention, mention may especially be made of polyethylene, polypropylene, polyisobutylene, polymethylpentene, polyisoprenes and blends and/or copolymers thereof.

A high-density polyethylene is especially preferred, in particular having the following characteristics:
density between 0.94 and 0.97 g/cm³;

molecular weight between 450 000 and 4 000 000 g/mol;
melt flow index (MFI) measured according to the ISO 1133 standard (190° C., 2.16 kg) between 0.1 and 25 g/10 mm; and degree of crystallization between 60 and 80%.

These high-density polyethylenes are sold under the trade names Lupolen 4261 AG by BASELL, Eraclene BB 76 by POLIMERI EUROPA.

The composition may comprise from 1 to 50% by weight of polyolefin, relative to the total weight of the composition, preferably from 5 to 30% by weight.

As the agent d) for compatibilization between the polyolefin and the polyamide, mention may be made of compounds comprising, in particular, polyolefin chains and functional groups intended to improve the compatibility with the polyamide, such as for example maleic anhydride, salified or unsalified carboxylic acid, ester, acrylic, methacrylic or epoxy groups. Grafted copolyolefins bearing such groups are especially preferred.

Use may especially be made of maleic anhydride-grafted polyethylenes, ethylene-propylene (EPR) copolymers or ethylene-propylene-diene (EPDM) copolymers grafted with maleic anhydride, ionomers, especially those of the Surlyn® range, copolymers of ethylene and acrylic.

The composition may comprise from 2 to 20% by weight of compatibilizing agent d), relative to the total weight of the composition, preferably from 5 to 15% by weight. Use is very preferably made of at least 30%, preferably at least 50% by weight of compatibilizing agent, relative to the weight of the polyolefin c).

The material or composition of the invention may also comprise other compounds or additives generally used in compositions based on a plastic matrix, such as for example: reinforcing or bulking fillers, heat stabilizers, nucleating agents, plasticizers, flame retardants, antioxidants, UV stabilizers, colorants, optical brighteners, lubricants, anti-blocking agents, matifying agents such as titanium oxide, processing aids, elastomers, adhesion agents, dispersants, pigments, impact modifiers, active-oxygen scavengers or absorbers, and/or catalysts.

The composition of the invention may especially comprise reinforcing or bulking fillers chosen from the group comprising fibrous fillers such as glass fibers, aramid fibers and carbon fibers; or mineral fillers such as aluminosilicate clays, kaolin, wollastonites, talcs, calcium carbonates, fluoromicas, calcium phosphates and derivatives. The weight concentration of the reinforcing or bulking fillers is advantageously between 1% and 50% by weight relative to the total weight of the composition, preferably between 15 and 50%.

There is no limitation on the types of impact modifiers. These are generally polymers of elastomers that can be used for this purpose. The resilience modifiers are generally defined as having an ASTM D-638 tensile strength of less than around 500 MPa. Examples of suitable elastomers are ethylene/acrylic ester/maleic anhydride, ethylene/propylene/maleic anhydride, EPDM (ethylene-propylene-diene monomer) optionally with a grafted maleic anhydride. The weight concentration of elastomer is advantageously between 0.1 and 30% relative to the total weight of the composition.

The materials and compositions of the invention are generally obtained by hot-blending the various constituents, for example in a single-screw or twin-screw extruder, at a sufficient temperature to keep the polyamide resin in the melt state; or cold-blended in a mechanical mixer in particular. Generally, the blend obtained is extruded in the form of rods which are cut into pieces in order to form granules. The novolac resin and the polyolefin may be added at any moment of the process for manufacturing the plastic material, especially by hot- or cold-blending with the plastic matrix.

The addition of the compounds and additives, such as the novolac resin, may be carried out by adding these compounds into the molten plastic matrix in pure form or in the form of a concentrated blend in a matrix such as, for example, a plastic matrix.

The granules obtained are then used as a raw material for feeding the processes for manufacturing articles such as the injection-molding, extrusion, extrusion-blow molding processes.

The invention also relates to the articles obtained by forming the composition of the invention, by any plastic conversion technique, such as for example by extrusion, such as for example the extrusion of foils and films or extrusion-blow molding; by molding such as for example compression molding, molding by thermoforming or by rotomolding; by injection such as for example injection molding or injection-blow molding.

The invention relates very particularly to articles of the type of those that contain or that transport a fluid, comprising at least one part based on a composition such as described previously. These are therefore generally hollow bodies or packaging films and articles. These articles are especially chosen from the group comprising: tanks, containers, vats, bottles, boxes, pipes, hoses, ducts, pump components, or derivatives.

The composition or material according to the present invention may be deposited or combined with another substrate, such as plastic materials for the manufacture of composite, in particular multilayer, articles. This deposition or this combination may take place by the known methods of co-extrusion, lamination, coating, overmolding, co-injection molding, multilayer injection-blow molding, or welding. Multilayer structures may be formed from one or more layers of material according to the invention. These layers may be combined, in particular by co-extrusion tie layers, with one or more other layers of one or more thermoplastic polymers, for example polyolefins such as polyethylene and polypropylene, polyvinyl chloride, polyethylene terephthalate, polybutylene terephthalate, PA-12, PA-6,10, PA-6,12, polyvinylidene fluoride (PVDF), polyphenylene sulfide (PPS), ethylene/vinyl alcohol copolymer (EVOH), and the PA-6/6,36, PA-6/6,9 and PA-6/6,10 copolymers.

Multilayer articles are especially preferred that comprise at least one layer obtained from a polyamide composition according to the invention comprising at least novolac resin, and at least one layer obtained from a composition comprising a polyolefin. Preferably, the polyolefin is of the same nature in both layers. More preferably still, the polyolefin is a polyethylene.

The films or foils thus obtained may be monoaxially-drawn or biaxially-drawn according to the known techniques for conversion of thermoplastics. The foils or the sheets may be cut, thermoformed and/or stamped out in order to give them the desired shape.

The expression “and/or” includes the meanings and, or, and also all the other possible combinations of the elements connected to this term.

Other details or advantages of the invention will appear more clearly in view of the examples given below solely by way of indication.

### EXPERIMENTAL SECTION

### Example 1

### Manufacture of Plastic Pipes

The compounds used were the following:
PA-6: TECHNYL S 40 (viscosity 4 measured in sulfuric acid) from RHODIA;
high-density polyethylene (HDPE): Eraclene BB 76 from POLIMERI EUROPA;
novolac: Rhenosin PR 95 from RHEIN CHEMIE;
PA-12: commercial pipes;
EVOH: Soarnol D2908 from NIPPON GOHSEI and
high-density polyethylene (HDPE) grafted with maleic anhydride: Polybond 3009 from Chemtura.

Pipes having a thickness of 1 mm (external diameter of 8 mm; internal diameter of 6 mm) were shaped by extrusion on a machine of trademark Mac.Gi, type TR 35/24 GM, using the various compounds as mentioned in Table 1. The pipes produced all comprise a single layer, except No. 6 (C4) which has 3 layers (inner, central and outer layer).

The processing characteristics were the following:
temperature of the extruder: 230° C.
screw speed: 8 rpm
motor torque: 4.7 amperes
extrusion outlet pressure: 2000 psi (pounds per square inch)
vacuum: −0.2 bar

The pipes were then stored for 48 h at 23° C. and 50% RH (relative humidity).

### Example 2

### Permeability to Gasoline

The permeability of the various pipes to gasoline was evaluated by measuring the weight loss as a function of time. The various pipes of Example 1 were dried in an oven under vacuum at 70° C. for 12 hours. The various pipes were filled with gasoline and said pipes were sealed. The pipes thus filled were weighed on a precision balance. The pipes were then placed in an oven at 40° C. for 100 days. At regular time intervals the pipes were weighed and the weight loss noted. The permeability was therefore measured statically.

The gasoline was composed, by volume, of: 45% of toluene, 45% isooctane and 10% ethanol.

The curve of weight loss as a function of time breaks down into two phases: a first induction phase (corresponding to the diffusion of the fluid through the wall of the pipe), then a second phase of reduction in the weight of the pipes (corresponding to the passage of one or more of the fluids through the wall of the pipe). The permeability, measured in g/m²/day, was calculated from the slope of the second phase.

TABLE 1

| | | Appearance time of | Permeability |
|---|---|---|---|
| Pipe | Composition | the second phase (day) | (g/m²/day) |
| 1 | PA-6 + 20% HDPE + | 55 | 0.8 |
| | 10% HDPE-g-MA + | | |
| | 5% novolac | | |
| 2 | PA-6 + 20% HDPE + | 88 | 0.3 |
| | 10% HDPE-g-MA + | | |
| | 10% novolac | | |
| C1 | PA-6 + 20% HDPE + | 20 | 1.2 |
| | 10% HDPE-g-MA | | |
| C2 | PA-12 | 0.2 | 18.8 |
| C3 | HDPE | 0.1 | 480 |
| C4 | HDPE/EVOH/HDPE | 4 | 0.5 |

It is thus observed that a polyamide pipe according to the invention comprising the novolac resin has excellent impermeability to gasoline, much greater than a polyamide pipe according to the prior art that does not comprise novolac. Furthermore, the impermeability to gasoline of a polyamide pipe according to the invention comprising novolac resin is greater than that of the three-layer (HDPE/EVOH/HDPE) pipes conventionally used in the field and that are considered to be the combination that has excellent impermeability to gasoline.

1.-15. (canceled)

16. A polyamide composition having high fluid barrier properties comprising:
a) a polyamide matrix;
b) a novolac resin;
c) from 5 to 30% by weight of a polyolefin devoid of functional groups useful for improving its compatibility with the polyamide; and
d) an agent for effecting compatibilization between the polyolefin and the polyamide.

17. The polyamide matrix composition as defined by claim 16, comprising from 0.1 to 20% by weight of novolac resin b).

18. The polyamide matrix composition as defined by claim 16, wherein said polyolefin c) has a density ranging from 0.910 to 0.97 g/cm³.

19. The polyamide matrix composition as defined by claim 16, wherein said polyolefin c) is selected from the group consisting of polyethylene, polypropylene, polyisobutylene, polymethylpentene, polyisoprene and blends and/or copolymers thereof.

20. The polyamide matrix composition as defined by claim 16, wherein said compatibilizing agent d) is a compound comprising at least polyolefin chains and functional groups useful for improving the compatibility with the polyamide.

21. The polyamide matrix composition as defined by claim 20, wherein said functional groups are selected from the group consisting of maleic anhydride, carboxylic acid, ester, acrylic, methacrylic and epoxy groups.

22. The polyamide matrix composition as defined by claim 16, comprising from 2 to 20% by weight of compatibilizing agent d), relative to the total weight of the composition.

23. The polyamide matrix composition as defined by claim 16, comprising at least 30% by weight of compatibilizing agent d), relative to the weight of the polyolefin c).

24. An impermeabilization system for a polyamide matrix comprising a novolac resin, a polyolefin that does not comprise functional groups useful for improving its compatibility with the polyamide, and an agent for effecting compatibilization between the polyolefin and the polyamide.

25. The impermeabilization system as defined by claim 24, wherein the components of said system are added together or deferred to a polyamide matrix.

26. A shaped article obtained by forming a polyamide matrix composition as defined by claim 16 by extrusion, molding or injection-molding conversion.

27. A composite shaped article comprising the polyamide matrix composition as defined by claim 16.

28. A composite shaped article comprising a multilayer article in which at least one layer comprises the polyamide matrix composition as defined by claim 16.

29. A multilayer composite shaped article comprising at least one layer which comprises the polyamide matrix composition as defined by claim 16, and at least one layer which comprises a polyolefin.

30. A pipe, tube, duct or tank comprising the polyamide matrix composition as defined by claim 16.
